(19) United States
(12) Patent Application Publication
(10) Pub. No.: US 2019/0050909 A1
(43) Pub. Date: Feb. 14, 2019

(54) SERVER AND METHOD FOR CONFIGURING A CHATBOT

(71) Applicant: KIK INTERACTIVE INC., Waterloo (CA)

(72) Inventors: Ryan MAYNARD, Waterloo (CA); Thomas SCHMORLEIZ, Waterloo (CA)

(21) Appl. No.: 16/057,072

(22) Filed: Aug. 7, 2018

Related U.S. Application Data
(60) Provisional application No. 62/542,447, filed on Aug. 8, 2017.

(51) Int. Cl. G06Q 30/02; H04L 12/58; G06F 17/27

(52) U.S. Cl. CPC G06Q 30/0269; H04L 51/02; G06Q 30/0217; H04L 51/046; G06F 17/278; G06Q 30/0277

(57) ABSTRACT

A server, method and computer readable medium for providing targeted content is provided. Input messages are received and output messages are sent via a network. A conversation agent generates the output message based on the input message. A targeted content generator selects a conversation module from a plurality of conversation modules and generates a plurality of targeted messages to be sent to a user.

### FIELD

The present specification relates generally to messaging applications, and specifically to autonomous messaging applications.

### BACKGROUND

Autonomous messaging applications, such as chatbots, also referred to as chatterbots, have grown in popularity in recent years. The capabilities and programmed behaviours of different autonomous messaging applications vary depending on their intended audience. For example, autonomous messaging applications intended for entertainment purposes may employ different language processing and response algorithms than those intended to respond to customer service messages or complete Turing Tests. In general, however, autonomous messaging applications can be configured to recognize various characteristics of a message, and to respond to the message differently depending on which characteristics were recognized in the message.

Extending the breadth of characteristics that the autonomous messaging applications can recognize (and therefore respond to appropriately) can be highly time-intensive for administrators. Autonomous messaging applications may therefore respond slowly (or not at all) to newly received messages. Accordingly, changing the autonomous messaging applications to generate different content is generally not done.

### SUMMARY

The present specification provides a server, method and computer readable medium for providing targeted content.

In accordance with an aspect of the specification, a server for providing targeted content is provided. The server includes a network interface connected to a network, the network interface configured to receive an input message from the network and to send an output message via the network. The server includes a memory storage unit in communication with the network interface, the memory storage unit configured to store a plurality of conversation modules. The server includes a conversation agent in communication with the network interface, the conversation agent configured to generate the output message based on the input message. The server includes a targeted content generator in communication with the network interface, wherein the targeted content generator selects a conversation module from the plurality of conversation modules and generates a plurality of targeted messages to be sent to a user.

According to another aspect of the specification, a method for providing targeted content is provided. The method involves receiving an input message from a network, generating an output messaged based on the input message, and sending the output message via the network. The method involves storing a plurality of conversation modules, selecting a conversation module from the plurality of conversation modules, and generating a plurality of targeted messages using the conversation module to be sent via the network.

According to another aspect of the specification, a non-transitory computer-readable medium encoded with codes, the codes for directing a processor to operate a controller to carry out a method for providing targeted content to a user, is provided. The method involves receiving an input message from a network, generating an output messaged based on the input message, and sending the output message via the network. The method involves storing a plurality of conversation modules, selecting a conversation module from the plurality of conversation modules, and generating a plurality of targeted messages using the conversation module to be sent via the network.

The targeted content generator may determine whether a conversation module is to be selected. The targeted content generator may determine whether a conversation module is to be selected based at least in part on a presence of a keyword related to the targeted content in the input message. The targeted content generator may determine whether a conversation module is to be selected based at least in part on whether a number of output messages generated by the conversation module exceeds a limit.

The conversation agent may generate the output message by selecting the output message from a table corresponding the input message with the output message. Selecting the output message from the table may involve applying natural language processing to the input message to extract a topic from the input message, wherein the table corresponds the topic with the output message.

The conversation agent may generate the output message by applying artificial intelligence to the input message, wherein the artificial intelligence is trained to generate output messages predicted to lead to engagement with the user.

The input message may be received from a computing device. The output message may be sent to the computing device.

The conversation module may generate a plurality of node messages. A nod message of the plurality of node messages may solicits a response from the user, wherein the response determines a subsequent node message.

The conversation module may send an advertisement message.

### BRIEF DESCRIPTION OF THE DRAWINGS

Reference will now be made, by way of example only, to the accompanying drawings in which:

FIG. 1 depicts a communications system, according to a non-limiting embodiment;

FIG. 2A depicts certain internal components of a computing device of the system of FIG. 1, according to a non-limiting embodiment;

FIG. 2B depicts certain internal components of a server of the system of FIG. 1, according to a non-limiting embodiment;

FIG. 3 depicts a method of providing targeted content, according to a non-limiting embodiment; and

FIG. 4 depicts a conversation module, according to a non-limiting embodiment.

### DETAILED DESCRIPTION OF THE EMBODIMENTS

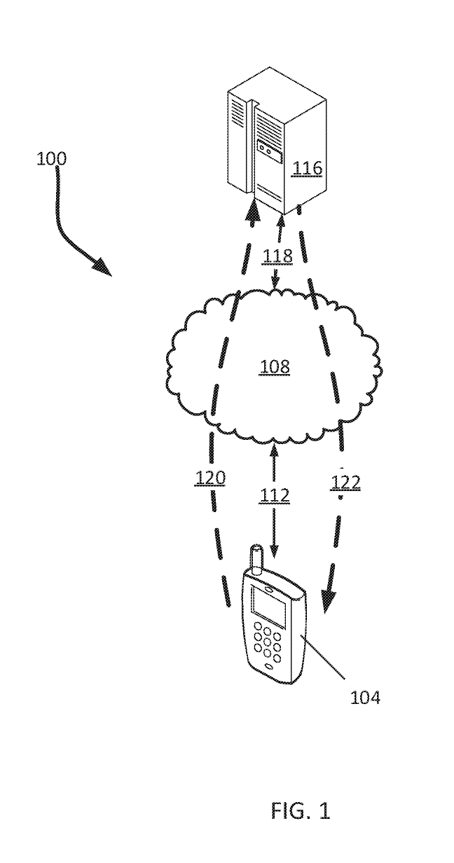

FIG. 1 depicts a communications system 100, according to a non-limiting embodiment. System 100 includes a computing device 104. Additional computing devices (not shown) can be included in system 100. The computing device 104 can be any of a cellular phone, a smart phone, a tablet computer, desktop PC, computer kiosk, and other devices that may have a chat plugin or program.

The computing device 104 is connected to a network 108 via a link 112, which is illustrated as a wireless link but can also be a wired link, or any suitable combination of wired and wireless links. Network 108 can include any suitable combination of wired and wireless networks, including but not limited to a Wide Area Network (WAN) such as the Internet, a Local Area Network (LAN) such as a corporate data network, cell phone networks, WiFi networks, WiMax networks and the like.

The computing device 104 can communicate with a server 116 connected to the network 108 via a link 118. The server 116 provides a messaging service to the computing device 104. For example, the computing device 104 can execute a messaging application for sending and receiving messages to and from the server 116. Such messages can include instant messages (e.g. Internet Protocol-based messages), Short Message Service (SMS) messages, Multimedia Messaging Service (MMS) messages and the like. In this example, as shown by the message path 120, the computing device 104 transmits a message to the server 116, and the server 116 generates and returns a response the computing device 104 via the message path 122. In other words, application server 116 functions as a chatbot, autonomously carrying on a conversation with a user of the computing device 104 by automatically responding to messages received from the computing device 104. In some embodiments, the server 116 can also route messages between computing device 104 and another computing device, however such embodiments are not discussed in detail herein.

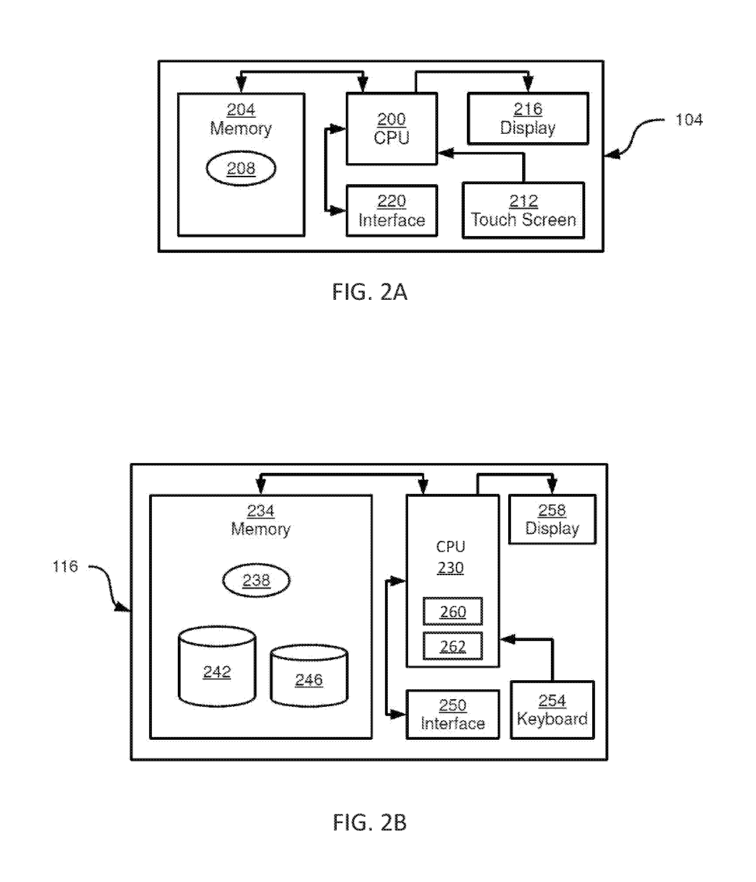

Before a detailed discussion of the operation of the system 100 is provided, certain components of the computing device 104 and the server 116 will be described with reference to FIGS. 2A and 2B, respectively, according to non-limiting embodiments.

Referring now to FIG. 2A, the computing device 104 includes a central processing unit (CPU) 200, also referred to herein as processor 200, interconnected with a memory 204. The memory 204 stores computer readable instructions executable by processor 200, including a messaging application 208. The processor 200 and the memory 204 are generally comprised of one or more integrated circuits (ICs), and can have a variety of structures, as will now occur to those skilled in the art (for example, more than one CPU can be provided). The processor 200 executes the instructions of the messaging application 208 to perform, in conjunction with the other components of the computing device 104, various functions related to exchanging messages with the server 116. In the below discussion of those functions, the computing device 104 is assumed to be configured to perform those functions—it will be understood that the computing device 104 is so configured via the processing of the instructions in the application 208 by the hardware components of the computing device 104 (including the processor 200 and the memory 204).

The computing device 104 also includes input devices interconnected with the processor 200, such as a touchscreen 212. The computing device 104 can also include other input devices, such as any suitable combination of a camera, a microphone, a GPS receiver, and the like (not shown). The computing device 104 also includes output devices interconnected with the processor 200, such as a display 216 integrated with the touchscreen 212. Other output devices can also be provided, such as a speaker (not shown). The computing device 104 also includes a network interface 220 interconnected with the processor 200, which allows the computing device 104 to connect to the network 108 via the link 112. The network interface 220 thus includes the necessary hardware, such as radio transmitter/receiver units, network interface controllers and the like, to communicate over the link 112.

Referring to FIG. 2B, the server 116 includes a central processing unit (CPU) 230, also referred to herein as processor 230, interconnected with a memory storage unit 234 and a network interface 250. The memory storage unit 234 stores computer readable instructions executable by the processor 230, including a chatbot application 238. The chatbot application 238 cooperates with the messaging application 208 on the computing device 104 to maintain a chat conversation between the chatbot application 238 running on the server 116 and a user of the computing device 104. The processor 230 and the memory storage unit 234 generally comprise one or more integrated circuits (ICs), and can have a variety of structures, as will now occur to those skilled in the art (for example, more than one CPU can be provided). The processor 230 executes the instructions of the chatbot application 238 to perform, in conjunction with the other components of the server 116, various functions related to receiving and responding to messages from the computing device 104. In the discussion below of those functions, the server 116 is said to be configured to perform those functions—it will be understood that the server 116 is so configured via the processing of the instructions in the chatbot application 238 by the hardware components of the server 116 (including the processor 230 and the memory storage unit 234).

The memory storage unit 234 also stores a message database 242, which contains messages received from the computing device 104 as well as other computing devices. In addition, stored in the memory storage unit 234 is a database 246, which contains a plurality of conversation modules. Conversation modules are configured to deliver targeted content into chat conversations. In the present embodiment, each conversation module is stored in a predetermined standardized format. However, in other embodiments, the conversation modules can be individually customized and include a plurality of targeted messages.

The server 116 also includes a network interface 250 interconnected with the processor 230, which allows the server 116 to connect to the network 108 via the link 118. The network interface 250 thus includes the necessary hardware, such as network interface controllers and the like, to communicate over the link 118. The network interface is configured to receive input messages from the network 108 and to send output messages via the network 108. For example, the input and output messages may be part of a chat conversation between the chatbot application 238 running on the server 116 and a user of the computing device 104. The server 116 also can include input devices interconnected with the processor 230, such as a keyboard 254, as well as output devices interconnected with the processor 230, such as a display 258. Other input and output devices (e.g. a mouse, speakers) can also be connected to the processor 230. In some embodiments (not shown), the keyboard 254 and the display 258 can be connected to the processor 230 via network 108 and another computing device. In other words, the keyboard 254 and the display 258 can be local (as shown in FIG. 2B) or remote. In further embodiments, the input and output devices such as the keyboard 254 and the display 258 can be omitted and the server 116 can be an autonomous system.

As will be described in greater detail below, for each input message received from the computing device 104, the server 116 generates an appropriate response to the message. In the present embodiment, the server 116 includes a conversation agent 260 configured to generate the output message. For example, in the present embodiment, the conversation agent 260 can be configured to use artificial intelligence to analyze the input message to generate a query. In this example, the input message can be a text representation of a natural language question. In such embodiments, natural language processing techniques may be applied to extract a topic from the input message. The conversation agent 260 can subsequently convert the natural language question into a machine readable query and execute the query. The result of the query can then be converted into an output message by the conversation agent 260. In other embodiments, the server 116 can analyze the input message to select a class definition from a database (not shown) that best fits the characteristics of that message. The server 116 can then generate an output message in response to the input message with a predefined response associated with the class. Classes can represent certain topics (e.g. pop culture, the weather, messages terminating a conversation). Predefined responses for each class are therefore geared towards the topic of the corresponding class.

The server 116 further includes a targeted content generator 262 configured to select a conversation module from the database 246. The targeted content generator 262 uses the conversation module to generate a plurality of targeted messages for a user. In the present embodiment, the targeted content generator 262 analyzes an input message to select a conversation module. Further, the targeted content generator may analyze the input messages to determine whether a conversation module is to be selected for insertion into a chat conversation. In other embodiments, the conversation modules can be selected at random times or in accordance with a predetermined scheduled.

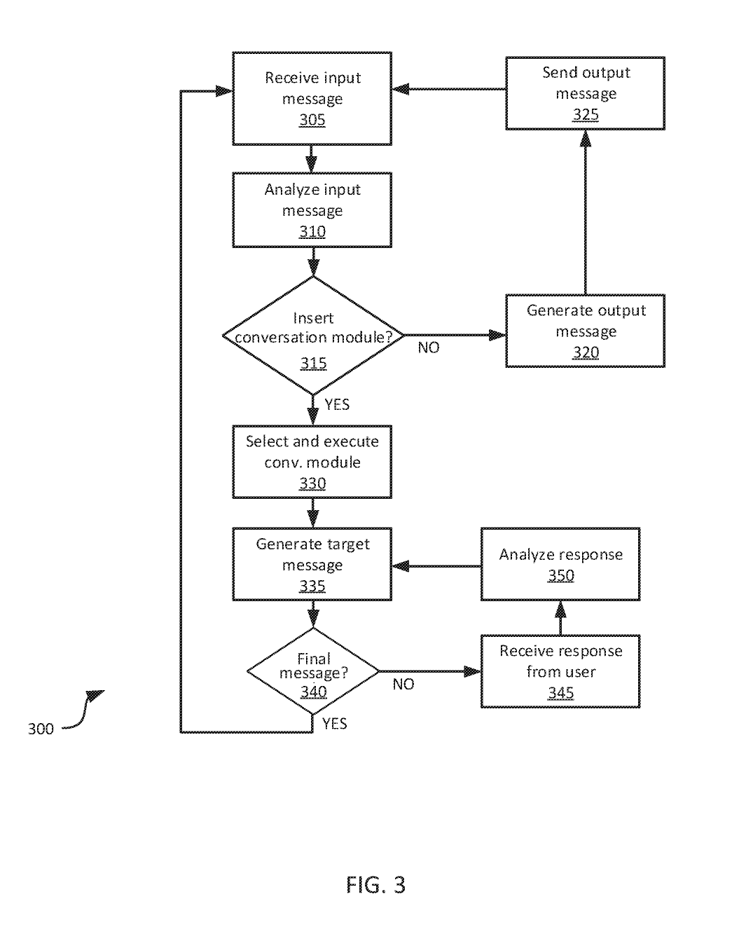

Referring to FIG. 3, a method of providing content to a user is represented in the form of a flow-chart and indicated generally at 300, according to a non-limiting embodiment. In order to assist in the explanation of the method 300, it will be assumed that the method 300 is performed using the system 100. Furthermore, the following discussion of the method 300 will lead to further understanding of the system 100 and its various components. In particular, it is to be understood that in one embodiment, the programming instructions stored in the memory storage unit 234 of the server 116 direct the processor 230 to carry out the methods discussed below. However, it is to be understood that the system 100 and/or the method 300 can be varied, and need not work exactly as discussed herein in conjunction with each other, and that such variations are within the scope of the present invention. Furthermore, it is to be emphasized, that method 300 need not be performed in the exact sequence as shown and that various blocks can be performed in parallel rather than in sequence; hence the elements of the method 300 are referred to herein as “blocks” rather than “steps”.

Block 305 comprises receiving an input message at the server 116 from a computing device 104. In the present embodiment, the input message is provided to the computing device 104 by a user of the computing device. In particular, the input message is stored in the message database 242 and intended for the chatbot application 238 operating on the server 116.

The manner by which the input message is received is not particularly limited. In the present embodiment, a user interacting with the computing device 104 can enter a message into the computing device 104 using the touchscreen 212. The message can be processed using the processor 200 and transmitted from the computing device 104 using the interface 220. The input message is then transmitted via the link 112 to the network 108. The server 116 subsequently retrieves the input message from the network 108 via the link 118 using the interface 250. In other embodiments, the computing device 104 can connected to the server 116 through multiple networks and/or devices. In other embodiments, the computing device 104 and the server 116 can be directly connected, for example through a wired or wireless connection, such that the network 108 can be omitted.

Block 310 comprises analyzing the input message to determine if a conversation module is to be inserted into a conversation. In the present embodiment, the server 116 searches for keywords in the input message. However, it is to be appreciated by a person of skill in the art with the benefit of this description that the analysis is not particularly limited. For example, in other embodiments, the analysis can involve applying an artificial intelligence algorithm to the input message to derive a classification or other meaning from the input message. In other embodiments, the analysis can also involve a counter to determine the number of occurrences of similar words or expressions in the input message.

Block 315 comprises using the analysis carried out at block 310 to determine if a conversation module is to be inserted into the conversation. The determination is not particularly limited and can involve various operations which can be carried out by the processor 230 using various predetermined factors. For example, the memory can store predetermined rules such as keyword matching rules where an input message having a matching keyword would result in a “yes” determination. Other examples can use a dictionary or thesaurus database to make the determination. In further examples, the input message can be classified into a predetermined classification system using an artificial intelligence algorithm where certain classes would trigger a “yes” determination. It is to be appreciated that a “yes” determination can be delayed until a predetermined number of instances. For example, if a keyword is mentioned twice in an input message, a determination of “yes” can be made. Although the present embodiment does not store and analyze the history of input messages stored in the message database 242, other embodiments can perform this function to further analyze a conversation a user carries out with the chatbot. If the determination results in a “no”, the method 300 proceeds to block 320.

Block 320 comprises generating an output message based on the input message received at block 305 using the conversation agent 260. The manner by which the output message is generated is not particularly limited. For example, the conversation agent 260 can use artificial intelligence to generate a natural response to the input message. In other embodiments, the conversation agent 260 can search and retrieve a response from a table stored in the memory storage unit 234. The table can include responses to common input messages such that searching for the input message would quickly provide one or more possible output messages.

Block 325 involves sending the output message generated at block 320. In the present embodiment, the output message is sent back to the computing device 104 via the network 108. However, it is to be appreciated by a person of skill in the art with the benefit of this description that the manner by which the output message is sent from the server 116 is not particularly limited and can involve any of the methods discussed above in connection with receiving the input message from the computing device 104.

It will now be apparent to a person of skill in the art that when the determination at block 315 is “no”, the method 300 cycles back to block 305. This cycle generally represents the normal operation of a chatbot for conversing with a user. When the determination made at block 315 results in a “yes”, the method 300 proceeds to block 330.

Block 330 comprises selecting a conversation module stored on the database 246 and executing the conversation module using the targeted content generator 262. The manner by which the conversation module is selected is not particularly limited. For example, the conversation module can be associated with one or more keywords obtained from the execution of block 310. As a specific example, a conversation module for a car manufacturer can be associated with the keywords “car”, “automobile”, “drive”, etc. In other embodiments, multiple conversation modules can be associated with a keyword. As a specific example, the keyword “car” can be associated with multiple conversation modules from competing car manufacturers. In cases where the targeted content generator 262 is provided with multiple conversation modules to select from, the targeted content generator 262 can select the conversation module randomly or in accordance with a priority rule, such as a priority determined using other factors including the amount of revenue provided by the conversation module designer, or other factors that can more accurately target the user sending the original input message, such as the location of the computing device 104, or as determined by an artificial intelligence algorithm.

The conversation module is not particularly limited and can include a wide variety of data structures and content. In the present embodiment, conversation modules allow for a typical chatbot to insert conversations within a conversation about a tangential topic. For example, the conversation module can provide a chatbot with the opportunity to insert a series of interactive messages seamlessly within a conversation between a user and the chatbot. Furthermore, the conversation module can provide a standard programming format for content creators to develop conversation modules with little programming training. Accordingly, some embodiments provide specialized conversation module builders with tools to enter standard targeted messages to be generated as discussed in greater detail below.

Block 335 comprises generating a targeted message to be sent to the computing device 104 for viewing by the user of the computing device. The exact content of the targeted message is not particularly limited and can include any content outlined by the selected conversation module. The generation of the targeted message may also consider prior analysis of a response (if any), such as from block 350 as discussed in greater detail below. Continuing with the present example where a conversation module from a car manufacturer is selected, the targeted content generator 262 can generate a targeted message such as “Are you interested in buying a car?” It is to be appreciated by a person of skill in the art with the benefit of description that the targeted message generated would not have been the same as an output message generated by the conversation agent 260. Once the targeted message is generated, the targeted message is sent via the network to the computing device 104 for the user.

Block 340 comprises determining whether the message generated at block 335 is the final message of the conversation module. The manner by which the determination is made is not particularly limited. In the present embodiment, the message generated at block 335 can be tagged with a message attribute such as a variable or additional field. During the execution of the conversation module by the targeted content generator 262, a predetermined limit can be set for the number of targeted messages generated. For example, the upper limit of targeted messages can be set at four in the present embodiment. However, other embodiments can set a limit higher or lower than four. It is to be appreciated by a person of skill in the art that a limit to the number of targeted messages can be used to limit the extent of the conversations between a user and the conversation module. In particular, if the user of the computing device 104 is not interested in the content of the conversation module, further targeted messages may serve no purpose other than to annoy the user of the computing device 104. In other embodiments, the determination can be made using a time limiter. For example, the targeted content generator 262 can be provided with a finite amount of time to execute the conversation module before returning to normal chatbot operation. When the determination made at block 340 results in a “yes”, the method 300 proceeds to block 305 and the execution of the conversation module is terminated. If the determination made at block 340 is a “no”, the method 300 proceeds to block 345.

Block 345 comprises receiving a response to the targeted message generated at block 335 from the user of the computing device 104. The manner by which the response is received is not particularly limited. In the present embodiment, each targeted message generated by block 335 includes a plurality of options which solicits a selection of one of the options from the user of the computing device 104. The exact number of options is not limited and can involve a binary decision (e.g. yes or no) or a selection from a list of multiple choice answers. In other embodiments, the response can be in the form of voice recording or a text string, such as one representing a phrase or sentence in natural language. In such embodiments, natural language processing techniques may be applied to extract a topic or a decision from the input message.

Block 350 comprises analyzing the response from the user of the computing device 104. In the present embodiment, the analysis is straightforward since the user selected from a list of possible selections. In other embodiments, the analysis may involve speech recognition, or machine reaching comprehension.

It will now be apparent to a person of skill in the art that when the determination at block 340 is “no”, the method 300 cycles back to block 335 and can continually loop with blocks 345 and 350. This cycle generally represents the execution of a conversation module which can pose several queries to a user of the computing device. In the present embodiment, each of the targeted messages can be considered a node message at which a response is solicited from a user that determines the next targeted message, which can be a follow-up node message or a final message.

The person skilled in the art will now recognize that method 300, system 100 and their variants can have many different implementations. For example, it is to be appreciated that although FIG. 2A illustrates that the single computing device 104, more computing devices are contemplated. Further, in the present embodiment, the method 300 is executed for each input message received at block 305. In other embodiments, one or more input messages may be received at block 305 before further blocks of the method 300 are executed. In such embodiments, the other blocks of method 300 may be performed on each input message received, or on a sequence of input messages.

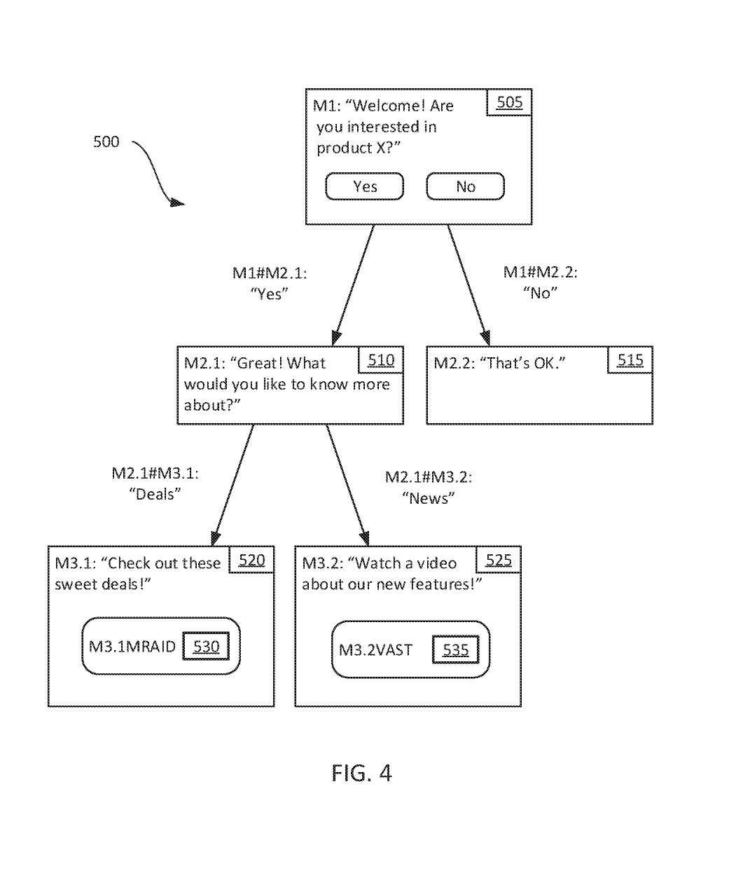

Referring to FIG. 4, a plurality of node messages is illustrated as a decision tree for a conversation module at 500, according to a non-limiting embodiment. This example is provided in order to assist in the explanation of the method 300. It is assumed that the conversation module 500 is used in by the method 300. Furthermore, the following discussion will also lead to further understanding of the system 100 and its various components. In the present embodiment, the conversation module 500 was developed by a manufacturer of product X which is for facilitating an activity Z.

During the execution of the method 300, an input message from the user of a computing device 104 can be received at block 305. Purely for explanatory purposes, it can be assumed that that the input message is a text string comprising “It would be nice to have something that can do activity Z to save me some time.” Carrying out the analysis at block 310 would cause the server 116 to realize that the keyword “activity Z” was in the input message. This would subsequently result in a determination of “yes” at block 315.

At block 330, the targeted content generator 262 selects the conversation module 500 from the database 246. Upon execution of the conversation module 500, the execution of block 335 would result in the node message 505 being generated. The node message 505 asks a binary question where a selection of YES or NO is provided. Execution of block 340 would result in a “no” since this is not a final message of the conversation module 500.

Block 345 receives a response from the user. Continuing with the present example, selection buttons can be provided or the user can input the words YES or NO on the computing device 104. Block 350 analyzes the response which involves providing the targeted content generator 262 with an indication on the next targeted message to send. If the response received at block 345 is NO, block 350 indicates to the targeted content generator 262 that disengaging message 515 is to be generated at block 335. Since the disengaging message 515 is a final message, the conversation module 500 is terminated and the method 300 returns to block 305 where the user of the computing device 104 can continue talking with the chatbot.

If the response received at block 345 is YES, block 350 indicates to the targeted content generator 262 that the node message 510 is to be generated at the next pass of block 335. Node message 510 is not a final message, so after a response to the message 510 is analyzed at block 350. In the present example, the conversation module 500 expects a natural language response, which may be analyzed for topics relating to “Deals” and “News”. Thus, executing block 350 involves natural language processing to extract a topic or decision from the user to determine whether the next target message to be generated at block 335 includes message 520, message 525, or another response. The node message 510 presents a user of the computing device with a promotional video 530 outlining offers, deals and other promotions. Node message 525 provides a user of the computing device with an informational video 535 providing information about product X.

Various advantages will now be apparent to a person of skill in the art. Of note is the ability to insert targeted content into a conversation with chatbot via a conversation module. This provides third parties, such as advertisers, with tools to provide targeted content to users carrying out conversations with a chatbot without having to redesign the chatbot or create a new chatbot when new sponsored messages or conversation modules are created by external marketing departments. Conversation modules can be programmed according to a standard programming format which requires little programming training.

Features such as impression pixels can be used to collect data and track the flow through each conversation module as well to provide analytics to advertisers. Impression pixels can be defined for each message and used when the message is sent from the computing device 104. This can provide data regarding the responses of a user received, for example, during the execution of block 345. Accordingly, the collected data can provide an advertiser with information regarding the behavior of the user in response to particular targeted content. For example, if a conversation module is executed and a user disengages with the conversation module, the data can provide information regarding what may have caused the user to disengage, for example, a price point, a particular promotional video, or a specific technical feature made known during the execution of the conversation module. As another example, the data collected can be used to improve marketing techniques that may capture the attention of users.

Accordingly, a user's behavior within a conversation module designed by an advertiser may be captured and made available to the advertiser. In particular, the number of responses to a specific targeted message can be collected. The optional impression pixels can also provide additional tracking information such as the number of users viewing a targeted message and not proceeding further with the conversation. By tracking the number of times a user opts out of answering a targeted message, information about the effectiveness of specific targeted messages within a conversation module can be obtained to improve the performance of the conversation module. Ad conversations may be constructed in a tree-like format and, as a user traverses the tree in their conversation they are inherently completing a survey for the advertiser. Further, in some embodiments, artificial intelligence techniques may be employed wherein the artificial intelligence is trained to generated output messages predicted to lead to engagement with a user. For example, the conversation module may be trained to select particular targeted messages which are predicted to lead to engagement with a user. The artificial intelligence may be trained using message database 242 and data describing the outcomes of various output messages.

Referring back to the conversation module tree of FIG. 4, tracking data can be collected from the interactions of the conversation module with multiple users or targets. Using this example, the data collected from the transmission of the node message 505 to the computing device can be assumed to have 100 responses from unique computing devices 104 to the node message 505. This means that all users have presumably viewed the options and selected one of the options provided.

Continuing with the present example, it can be assumed that 60 computing devices have selected “No” and that 40 computing devices have selected “yes”. In this present embodiment, it is assumed that in order to vote, a user of the computing device has read and understood the node message 505 and made an informed decision. Accordingly, tracking information obtained from the first level of the conversation module 500 can include an indication that when a question about product X resulted in 100 percent participation at this level. The selection of “no” by the 60 responses merely ends the conversation module with the generation of the disengaging message 515.

When the computing devices select “yes” to the node message 505, another node message 510 is generated. Using the impression pixel, it can be assumed that 30 computing devices view the option presented by node message 510 and that 20 computing devices selected an option. Accordingly, further information can be obtained from this level. For example, ten computing devices did not view the options presented by the node message 510. This can be a result of various factors that can also be associated with the user of the computing device deciding to longer participate in the conversation with the chatbot.

Further information collected from the node message 510 can be that ten computing devices viewed the options but failed to make a selection within a predetermined time threshold. Accordingly, this information can suggest that the node message 510 may need to be re-evaluated to ensure that the content of the node message 510 is not the cause for a user of a computing device to opt out of answering the node message 510.

Continuing with the present example, it can be assumed that 15 computing devices replied with “Deals” and 5 devices replied with “News”. Using the impression pixel, it can be used to determine an estimate the number of computing devices that view the video 530 and/or the video 535, respectively.

It is to be appreciated that the manner by which analytics can be provided to advertisers is not limited. For example, the data can be provided using an API where the advertiser can access the information at any time. The information can also be presented in a dashboard for ease of reading.

The scope of the claims should not be limited by the embodiments set forth in the above examples, but should be given the broadest interpretation consistent with the description as a whole.

What is claimed is:

1. A server for providing targeted content to a user, the server comprising:
a network interface connected to a network, the network interface configured to receive an input message from the network and to send an output message via the network;
a memory storage unit in communication with the network interface, the memory storage unit configured to store a plurality of conversation modules;
a conversation agent in communication with the network interface, the conversation agent configured to generate the output message based on the input message; and
a targeted content generator in communication with the network interface, wherein the targeted content generator selects a conversation module from the plurality of conversation modules and generates a plurality of targeted messages to be sent to the user.

2. The server of claim 1, wherein, prior to the targeted content generator selecting the conversation module, the targeted content generator determines whether a conversation module is to be selected.

3. The server of claim 2, wherein the targeted content generator determines whether a conversation module is to be selected based at least in part on a presence of a keyword related to the targeted content in the input message.

4. The server of claim 2, wherein the targeted content generator determines whether a conversation module is to be selected based at least in part on whether a number of output messages generated by the conversation module exceeds a limit.

5. The server of claim 1, wherein the conversation agent generates the output message by selecting the output message from a table corresponding the input message with the output message.

6. The server of claim 5, wherein selecting the output message from the table comprises applying natural language processing to the input message to extract a topic from the input message, and wherein the table corresponds the topic with the output message.

7. The server of claim 1, wherein the conversation agent generates the output message by applying artificial intelligence to the input message, wherein the artificial intelligence is trained to generate output messages predicted to lead to engagement with the user.

8. The server of claim 1, wherein the input message is received from a computing device.

9. The server of claim 8, wherein the output message is sent to the computing device.

10. The server of claim 1, wherein the conversation module is configured to generate a plurality of node messages.

11. The server of claim 10, wherein a node message of the plurality of node messages solicits a response from the user, wherein the response determines a subsequent node message.

12. The server of claim 11, wherein the conversation module is configured to send an advertisement message.

13. A method for providing targeted content to a user, the method comprising:
receiving an input message from a network;
generating an output message based on the input message;
sending the output message via the network;
storing a plurality of conversation modules;
selecting a conversation module from the plurality of conversation modules; and
generating a plurality of targeted messages using the conversation module to be sent via the network.

14. The method of claim 13, further comprising:
prior to selecting the conversation module, determining whether a conversation module is to be selected.

15. The method of claim 14, wherein determining whether a conversation module is to be selected comprises determining whether a keyword related to the targeted content is present in the input message.

16. The method of claim 14, wherein determining whether a conversation module is to be selected comprises determining whether a number of output messages generated by the conversation module exceeds a limit.

17. The method of claim 13, wherein generating the output message comprises selecting the output message from a table corresponding the input message with the output message.

18. The method of claim 17, wherein selecting the output message from the table comprises applying natural language processing to the input message to extract a topic from the input message, and wherein the table corresponds the topic with the output message.

19. The method of claim 13, wherein generating the output message comprises applying artificial intelligence to the input message, wherein the artificial intelligence is trained to generate output messages predicted to lead to engagement with the user.

20. A non-transitory computer-readable medium encoded with codes, the codes for directing a processor to operate a controller to carry out a method for providing targeted content to a user, the method comprising:
receiving an input message from a network;
generating an output message based on the input message;
sending the output message via the network;
storing a plurality of conversation modules;
selecting a conversation module from the plurality of conversation modules; and
generating a plurality of targeted messages using the conversation module to be sent via the network.
